(19) United States
(12) Patent Application Publication
(10) Pub. No.: US 2018/0288492 A1
(43) Pub. Date: Oct. 4, 2018

(54) BROADCAST RECEPTION DEVICE AND BROADCAST RECEPTION METHOD

(71) Applicant: JVC KENWOOD Corporation, Yokohama-shi (JP)

(72) Inventors: Katsuhiko SAKYU, Yokohama-shi (JP); Yoshitsugu KOJIMA, Yokohama-shi (JP)

(21) Appl. No.: 15/937,889

(22) Filed: Mar. 28, 2018

(30) Foreign Application Priority Data
Apr. 3, 2017 (JP) 2017-073540

(51) Int. Cl. H04N 21/647; H04N 21/438

(52) U.S. Cl. CPC H04N 21/647; H04N 21/4383

(57) ABSTRACT

A broadcast reception device includes a plurality of reception units that receive a broadcast signal and a control unit that causes one of the reception units to select a designated broadcast station (D-station) and causes another one of the reception units to search for a relay or affiliate station (R/A-station) corresponding to the designated broadcast station. When a reception sensitivity for the D-station is less than a reference value and when a reception sensitivity for the R/A-station is equal to or more than the reference value, the control unit causes the R/A-station to be selected. When the reception sensitivity for the D-station is less than the reference value and when the reception sensitivity for the R/A-station is less than the reference value, the control unit causes the D-station to continue to be selected.

### CROSS REFERENCE TO RELATED APPLICATION

Priority is claimed to Japanese Patent Application No. 2017-073540, filed on Apr. 3, 2017, the entire content of which is incorporated herein by reference.

### BACKGROUND

### 1. Field of the Invention

The present invention relates to a broadcast reception device and a broadcast reception method.

### 2. Description of the Related Art

In a vehicle-mounted television set, the reception status of the television broadcast signal or the broadcast station from which reception is enabled vary as the vehicle on which the television set is mounted moves. For example, when the vehicle enters a different broadcast area, it is preferable to select a broadcast station adapted to the destination broadcast area. For smooth switching to take place in the event of a change in broadcast area, the first tuner receives the channel currently being viewed and the second tuner searches for a relay station or an affiliate (network) station. If the reception status of the channel currently being viewed becomes poor, automatic switching to the channel of the relay station or the affiliate station identified by the search takes place.

If the reception status of the broadcast signal becomes poor as the vehicle on which the television set is mounted enters a tunnel or an underground facility, the reception status for the relay station or the affiliate station identified by the search also becomes poor. Automatic channel switching in this case may require a process of re-switching to the original channel when the vehicle leaves the tunnel or the underground facility and the reception status recovers. In this case, a certain period of time is consumed since the recovery of the reception status until the channel being viewed is started to be displayed again.

### SUMMARY

The broadcast reception device according to an embodiment of the present invention comprises: a plurality of reception units that receive a broadcast signal; a control unit that causes at least one of the plurality of reception units to select a channel of a designated broadcast station designated by a user and causes at least another one of the plurality of reception units to search for a channel of a relay station or an affiliate station corresponding to the designated broadcast station; and a playback processing unit that plays back broadcast content received in the selected channel. When a reception sensitivity for the designated broadcast station is less than a reference value and when a reception sensitivity for the relay station or the affiliate station identified by a search is equal to or more than the reference value, the control unit causes the channel of the relay station or the affiliate station to be selected and causes broadcast content received in the channel for the relay station or the affiliate station to be played back, and when the reception sensitivity for the designated broadcast station is less than the reference value and when the reception sensitivity for the relay station or the affiliate station identified by the search is less than the reference value, the control unit causes the designated broadcast station to continue to be selected.

Another embodiment of the present invention relates to a broadcast reception method. The method comprises: causing at least one of a plurality of reception units select a channel of a designated broadcast station designated by a user and causing at least another one of the plurality of reception units to search for a channel of a relay station or an affiliate station corresponding to the designated broadcast station; when a reception sensitivity for the designated broadcast station is less than a reference value and when a reception sensitivity for the relay station or the affiliate station identified by a search is equal to or more than the reference value, causing the channel of the relay station or the affiliate station to be selected and causing broadcast content received in the channel for the relay station or the affiliate station to be played back; and when the reception sensitivity for the designated broadcast station is less than the reference value and when the reception sensitivity for the relay station or the affiliate station identified by the search is less than the reference value, causing the designated broadcast station to continue to be selected.

Optional combinations of the aforementioned constituting elements, and implementations of the invention in the form of methods, apparatuses, and systems may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically showing a functional configuration of a broadcast reception device; and

FIG. 2 is a flowchart schematically showing the flow of a method of receiving broadcast.

### DETAILED DESCRIPTION

The invention will now be described by reference to the preferred embodiments. This does not intend to limit the scope of the present invention, but to exemplify the invention.

A description will be given of embodiments of the present invention with reference to the drawings. Specific numerical values are shown in the embodiments by way of example only to facilitate the understanding of the invention and should not be construed as limiting the scope of the invention unless specifically indicated as such. Those elements in the specification and drawings that have substantially identical functions and structures are represented by the same reference symbols so that the description is not duplicated. Elements not relevant to the invention directly are omitted from the illustration.

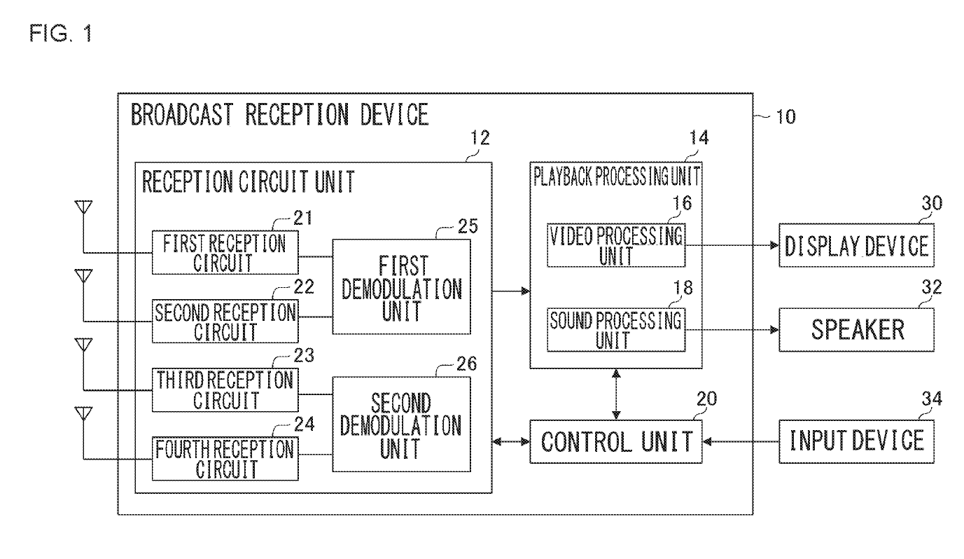

FIG. 1 is a block diagram schematically showing a functional configuration of a broadcast reception device 10. The functional blocks depicted are implemented in hardware such as devices or mechanical components such as a CPU or a memory of a computer, and in software such as a computer program. FIG. 1 depicts functional blocks implemented by the cooperation of these elements. Therefore, it will be obvious to those skilled in the art that the functional blocks may be implemented in a variety of manners by a combination of hardware and software.

The broadcast reception device 10 is a device for receiving digital television broadcast and is a vehicle-mounted digital television reception device mounted on a moving object such as a vehicle for use. The broadcast content received by the broadcast reception device 10 is played back via a display device 30 and a speaker 32. The user selects a channel desired to be viewed via an input device 34. When the reception sensitivity in the selected channel is proper, the broadcast content of the designated channel is displayed or output.

The broadcast reception device 10 comprises a reception circuit unit 12, a playback processing unit 14, and a control unit 20. The broadcast reception device 10 is connected to a display device 30, a speaker 32, and an input device 34. The display device 30 is a liquid crystal display or the like and is mounted at the position of the center console or the dashboard of the vehicle. The speaker 32 may be a vehicle-mounted speaker or a speaker provided adjacent to the display device 30. The input device 34 is, for example, a touch-panel sensor and is provided in the display area of the display device 30. The input device 34 may not be touch-sensitive and may be comprised of a button, etc. provided around the display device 30.

The reception circuit unit 12 includes a first reception unit 21, a second reception unit 22, a third reception unit 23, a fourth reception unit 24, a first demodulation unit 25, and a second demodulation unit 26. Different antennas are connected to the plurality of reception units 21˜24. The reception units 21˜24 receive the broadcast signal of the selected channel via the respective antennas. Each of the plurality of reception units 21˜24 is configured to receive, for example, a terrestrial digital broadcast signal.

The first demodulation unit 25 is connected to the first reception unit 21 and the second reception unit 22 and demodulates the broadcast signal received by the first reception unit 21 and the second reception unit 22. The second demodulation unit 26 is connected to the third reception unit 23 and the fourth reception unit 24 and demodulates the broadcast signal received by the third reception unit 23 and the fourth reception unit 24. Each of the plurality of demodulation units 25 and 26 is configured, for example, to generate a transport stream (TS) signal from the received terrestrial digital broadcast signal.

The first demodulation unit 25 is configured to synthesize and demodulate the received signal of the first reception unit 21 and the received signal of the second reception unit 22 and is configured to generate a demodulated signal in a so-called twin diversity reception scheme. Similarly, the second demodulation unit 26 is configured to synthesize and demodulate the received signal of the third reception unit 23 and the received signal of the fourth reception unit 24. Using the diversity reception scheme improves the reception performance exhibited while the vehicle on which the device is mounted is moving.

The reception circuit unit 12 may be configured to implement triple or more diversity reception. Alternatively, the reception circuit unit 12 may be configured not to use diversity reception. Where diversity reception is not used, the reception circuit unit 12 may be configured such that one demodulation unit is provided for one reception unit. Alternatively, the diversity reception scheme may be switched in accordance with the sensitivity of the received signal. For example, the received signals of the four reception units 21˜24 may be synthesized and demodulated when the sensitivity of the received signal is low.

The playback processing unit 14 plays back the broadcast content from the TS signal generated by the first demodulation unit 25 and the second demodulation unit 26. The playback processing unit 14 includes a video processing unit 16 and a sound processing unit 18. The video processing unit 16 extracts video data from the acquired TS signal and causes the display device 30 to display a video based on the extracted video data. The sound processing unit 18 extracts sound data from the acquired TS signal and causes the speaker 32 to output sound based on the extracted sound data.

The playback processing unit 14 extracts program information, data broadcast information, etc. included in the TS signal and generates a display screen for displaying the extracted information on the display device 30. The playback processing unit 14 generates a user operation screen to allow the user to enter a user input via the input device 34. For example, the playback processing unit 14 generates a screen to enable selection of the channel, luminance adjustment on the display device 30, and sound adjustment of the speaker 32 by the user. The playback processing unit 14 generates a display screen for giving a notification of an error such as disabled reception, when the channel being selected cannot be received.

The control unit 20 controls the operation of the reception circuit unit 12 and the playback processing unit 14. The control unit 20 causes the reception circuit unit 12 to select the channel of the broadcast station designated by the user (also referred to as designated broadcast station or “D-station”) so as to cause the broadcast content received in the channel of the designated broadcast station to be played back. The control unit 20 searches for an affiliate station or a relay station corresponding to the designated broadcast station so that smooth switching is enabled in the event that the broadcast area is switched due to the movement of the vehicle on which the television set is mounted. When the broadcast area is changed, it is ensured that the channel being viewed is seamlessly displayed by performing automatic switching to the broadcast station of a higher reception sensitivity.

The relay station is a broadcast station for receiving radio waves of a parent broadcast station and broadcasting the amplified radio waves. For example, given the same channel, the relay station outputs radio waves carrying the same broadcast content as that of the parent broadcast station. Meanwhile, the affiliate station is a broadcast station for each local area belonging to the same network as one of main broadcast stations (key stations). The affiliate station uses the same channel as the main broadcast station or uses a different channel to either output radio waves carrying broadcast content broadcast in common in the main broadcast station or output radio waves carrying unique broadcast content determined by the affiliate station, depending on the broadcast time zone.

The control unit 20 causes at least one of the plurality of reception units 21˜24 to select the channel of the designated broadcast station and causes at least another one of the plurality of reception units 21˜24 to search for the relay station or the affiliate station (also referred to “R/A-station”) corresponding to the designated broadcast station. For example, the control unit 20 causes the first reception unit 21 and the second reception unit 22 to select the channel of the designated broadcast station and causes the third reception unit 23 and the fourth reception unit 24 to search for the channel of the relay station or the affiliate station. The third reception unit 23 and the fourth reception unit 24 cyclically select channels in which reception is enabled, and the second demodulation unit 26 demodulates the TS signals of the respective channels selected cyclically.

The control unit 20 refers to the demodulated TS signal and identifies the channel of the relay station or the affiliate station corresponding to the designated broadcast station. For example, the control unit 20 identifies the channel of the relay station or the affiliate station based on the broadcast station identification information included in the TS signal. The control unit 20 may retain table information defining a network of affiliate broadcast stations and may identify the channel of the corresponding relay station or the affiliate station by referring to the retained table information.

The control unit 20 may exclude the designated broadcast station from the candidates of the search by the third reception unit 23 and the fourth reception unit 24. By excluding the designated broadcast station from the candidates of the search by the third reception unit 23 and the fourth reception unit 24, the time required for a cycle of selections of the stations can be reduced.

The control unit 20 acquires from the reception circuit unit 12 information related to the reception sensitivity in the channel in which reception is enabled. For example, the control unit 20 acquires the reception sensitivity for the designated broadcast station that the first reception unit 21 and the second reception unit 22 receive from and the reception sensitivity for the relay station or the affiliate station that the third reception unit 23 and the fourth reception unit 24 receive from. If the acquired reception sensitivity is equal to or more than a predetermined reference value, the control unit 20 determines that reception is enabled. If the acquired reception sensitivity is less than than the predetermined reference value, the control unit 20 determines that reception is not enabled.

The control unit 20 determines the channel to select in accordance with the reception sensitivity in the channel being viewed and the reception sensitivity in the channel identified by the search. If the reception sensitivity in the channel being viewed is equal to or more than the reference value, the control unit 20 continues to select the channel being viewed, i.e., the designated broadcast station designated by the user. If the reception sensitivity in the channel being viewed is less than the reference value and reception is not enabled, the control unit 20 checks the reception sensitivity for the relay station or the affiliate station identified by the search. More specifically, the control unit 20 causes the third reception unit 23 and the fourth reception unit 24 to select the relay station or the affiliate station identified by the search and acquires information related to the reception sensitivity in the channel of the relay station or the affiliate station being selected. If the reception sensitivity for the relay station or the affiliate station is equal to or more than the threshold value and reception is enabled, the control unit 20 selects the relay station or the affiliate station and causes the broadcast content received in the channel of the selected relay station or the affiliate station to be played back. In this way, the broadcast content is played back in a stable manner using the broadcast signal from the relay station or the affiliate station for which the reception sensitivity is proper.

Meanwhile, if the reception sensitivity for the relay station or the affiliate station is also less than the reference value and reception is not enabled, the relay station or the affiliate station is not selected and the designated broadcast station from which reception is not enabled continues to be selected. In the case where reception is not enabled in both the channel being viewed and the channel identified by the search, it is considered that the vehicle on which the television set is mounted is in a place such as a tunnel and an underground facility where broadcast waves do not reach. If the channel is automatically switched in this case, the post-switching channel is not viewable, either, so that channel switching does not provide any merit. If the channel recovers to a viewable status as the vehicle leaves the tunnel or the underground facility, it is highly likely that the reception sensitivity for the designated broadcast station is equally as good as before when the channel became unviewable. Automatic switching from the designated broadcast station to the relay station or the affiliate station in this case requires the designated broadcast station to be selected after reception becomes enabled so that a long period of time is required to return to a status in which the channel being viewed is played back. The embodiment addresses this by continuing to select the original channel without automatically changing the channel, if reception is not enabled in both the channel being viewed and the channel identified by the search. This allows the channel being selected to be played back the moment that reception is enabled. This can reduce the time elapsed since the recovery of the reception status until a return to a status in which the channel can be viewed and can improve the convenience for the user.

If reception is not enabled in both the channel being viewed and the channel identified by the search, a search for the relay station or the affiliate station may be discontinued temporarily. This is because of the small merit of selecting channels cyclically where broadcast waves do not reach. By discontinuing a search for the relay station or the affiliate station temporarily, the channel being selected can be restarted when the reception sensitivity in the channel being viewed recovers, and, at a point of time earlier than when cyclic selection is made. When the reception status of the channel being viewed recovers while a search for the relay station or the affiliate station is discontinued temporarily, the control unit 20 may restart a search for the relay station or the affiliate station.

If the reception status in the channel being viewed does not recover after an elapse of a predetermined period of time since the search for the relay station or the affiliate station was discontinued temporarily, the search for the relay station or the affiliate station may be restarted. For example, if the search is not restarted after an elapse of several to 10 minutes since the search was discontinued temporarily, the search discontinuation function may be reset. This allows the search to be restarted to enable automatic switching to the relay station or the affiliate station from which reception is enabled, even in the case where, for example, the vehicle travels through a tunnel extending across broadcast areas so that reception from the channel being viewed becomes disabled.

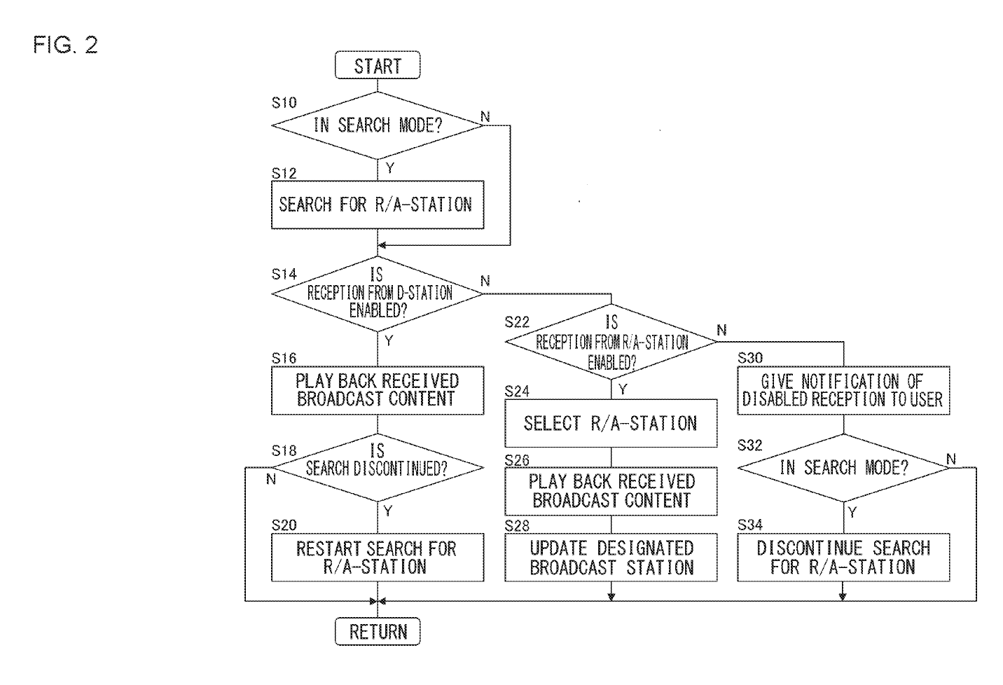

FIG. 2 is a flowchart schematically showing the flow of a method of receiving broadcast. If the broadcast reception device 10 is in a search mode of searching for the relay station or the affiliate station (Y in S10), the broadcast reception device 10 searches for the relay station or the affiliate station (R/A-station) corresponding to the designated broadcast station (D-station) in the background (S12). In a search discontinuation mode in which the search is discontinued temporarily (N in S10), step S12 is skipped. If reception from the designated broadcast station is enabled (Y in S14), the broadcast content of the designated broadcast station received is played back (S16). If the broadcast reception device 10 is in the search discontinuation mode in this case (Y in S18), the search for the relay station or the affiliate station is restarted (S20). If the broadcast reception device 10 is in the search mode (N in S18), step S20 is skipped and step S10 and the subsequent steps are repeated.

Meanwhile, if reception from the designated broadcast station is not enabled (N in S14) and if reception from the relay station or the affiliated station identified by the search is enabled (Y in S22), the channel of the relay station or the affiliate station from which reception is enabled is selected (S24) and the broadcast content of the relay station or the affiliate station received is played back (S26). Further, the channel of the selected relay station or the affiliate station is updated as a designated broadcast station (S28), and step S10 and the subsequent steps are repeated. In this case, if reception from the selected relay station or the affiliate station is enabled, the relay station or the affiliate station is defined as the new designated broadcast station and step S16 is performed accordingly.

If reception from the designated broadcast station is not enabled (N in S14) and reception from the relay station or the affiliate station identified by the search is not enabled, either (N in S22), the user is notified that reception is not enabled (S30). If the broadcast reception device 10 is in the search mode (Y in S32), the search for the relay station or the affiliate station is discontinued (S34). Subsequently, S10 and the subsequent steps are repeated. In this case, the broadcast reception device 10 is in the search discontinuation state so that step S12 is skipped. As long as reception from the designated broadcast station is disabled (N in S14), the user is notified that reception is not enabled (S30). Since the broadcast reception device 10 is in the search discontinuation state (N in S32), step S34 is skipped. Meanwhile, if reception becomes enabled in the designated broadcast station (Y in S14), playback of the broadcast content of the designated broadcast station received is restarted (S16). Since the broadcast reception device is in the search discontinuation mode (Y in S18), the search for the relay station or the affiliate station is restarted (S20).

If it is determined in S10 that the search is being discontinued and if a predetermined period of time has elapsed since the search was discontinued, the search for the relay station or the affiliate station may be restarted and step S12 may be executed without being skipped.

The embodiments of the present invention are not limited to those described above and appropriate combinations or replacements of the features of the embodiments are also encompassed by the present invention.

In the above embodiment, the broadcast reception device 10 for receiving terrestrial digital broadcast is described. In a variation, the inventive feature may be applied to a broadcast reception device for receiving broadcast other than terrestrial digital broadcast. For example, the aforementioned automatic switching to the relay station or the affiliate station, or discontinuation and restart of the search may be applied to a broadcast reception device for receiving radio broadcast.

It should be understood that the invention is not limited to the above-described embodiment but may be modified into various forms on the basis of the spirit of the invention. Additionally, the modifications are included in the scope of the invention.

What is claimed is:

1. A broadcast reception device comprising:
a plurality of reception units that receive a broadcast signal;
a control unit that causes at least one of the plurality of reception units to select a channel of a designated broadcast station designated by a user and causes at least another one of the plurality of reception units to search for a channel of a relay station or an affiliate station corresponding to the designated broadcast station; and
a playback processing unit that plays back broadcast content received in the selected channel, wherein
when a reception sensitivity for the designated broadcast station is less than a reference value and when a reception sensitivity for the relay station or the affiliate station identified by a search is equal to or more than the reference value, the control unit causes the channel of the relay station or the affiliate station to be selected and causes broadcast content received in the channel for the relay station or the affiliate station to be played back, and
when the reception sensitivity for the designated broadcast station is less than the reference value and when the reception sensitivity for the relay station or the affiliate station identified by the search is less than the reference value, the control unit causes the designated broadcast station to continue to be selected.

2. The broadcast reception device according to claim 1, wherein
when the reception sensitivity for the designated broadcast station recovers to the reference value or more, the playback processing unit restarts playback of the broadcast content received in the designated broadcast station that continues to be selected.

3. The broadcast reception device according to claim 1, wherein
when the reception sensitivity for the designated broadcast station is less than the reference value and when the reception sensitivity for the relay station or the affiliate station identified by the search is less than the reference value, the control unit discontinue the search for the relay station or the affiliate station temporarily.

4. The broadcast reception device according to claim 3, wherein
when the reception sensitivity for the designated broadcast station recovers to the reference value or more while the search for the relay station or the affiliate station is being discontinued temporarily, the control unit restart the search for the relay station or the affiliate station.

5. The broadcast reception device according to claim 1, wherein
the control unit excludes the channel of the designated broadcast station from targets of the search for the relay station or the affiliate station.

6. A broadcast reception method comprising:
causing at least one of a plurality of reception units select a channel of a designated broadcast station designated by a user and causing at least another one of the plurality of reception units to search for a channel of a relay station or an affiliate station corresponding to the designated broadcast station;
when a reception sensitivity for the designated broadcast station is less than a reference value and when a reception sensitivity for the relay station or the affiliate station identified by a search is equal to or more than the reference value, causing the channel of the relay station or the affiliate station to be selected and causing broadcast content received in the channel for the relay station or the affiliate station to be played back; and
when the reception sensitivity for the designated broadcast station is less than the reference value and when the reception sensitivity for the relay station or the affiliate station identified by the search is less than the reference value, causing the designated broadcast station to continue to be selected.

7. A non-transitory computer readable recording medium encoded with a program including the modules comprising:
a module to cause at least one of a plurality of reception units select a channel of a designated broadcast station designated by a user and cause at least another one of the plurality of reception units to search for a channel of a relay station or an affiliate station corresponding to the designated broadcast station;
a module to cause, when a reception sensitivity for the designated broadcast station is less than a reference value and when a reception sensitivity for the relay station or the affiliate station identified by a search is equal to or more than the reference value, the channel of the relay station or the affiliate station to be selected and cause broadcast content received in the channel for the relay station or the affiliate station to be played back; and
a module to cause, when the reception sensitivity for the designated broadcast station is less than the reference value and when the reception sensitivity for the relay station or the affiliate station identified by the search is less than the reference value, the designated broadcast station to continue to be selected.
